(19) United States
(12) Patent Application Publication
(10) Pub. No.: US 2011/0140678 A1
(43) Pub. Date: Jun. 16, 2011

(54) Current limit recovery circuit

(76) Inventor: Philip W. Yee, Los Altos, CA (US)

(21) Appl. No.: 12/653,452

(22) Filed: Dec. 14, 2009

(51) Int. Cl. G05F 1/46

(52) U.S. Cl. 323/282

(57) ABSTRACT

The present invention provides a synchronous buck switcher including a first loop, second loop, a current limit switch, a capacitor and an RS flip flop. The first loop includes an error amplifier (EA), a pulse width modulator (PWM), a PMOS device and an NMOS device. The second loop includes a second capacitor and a resistor connected between the output terminal of the EA and an input terminal of the EA. During a current limit event, a current limit pulse is applied to the current limit switch which allows the input voltage at the inverting terminal of the EA to follow the decreasing output voltage due to the current limit event. As a result, regulation occurs at this lower voltage at the inverting input of the EA. The inverting input of the EA is then charged back to the original reference voltage, resulting in a smooth recovery from current limit.

### FIELD OF THE INVENTION

The present invention relates, in general, to synchronous buck switchers for DC to DC converters, and more particularly to a circuit for current limit recovery in a synchronous buck switcher.

### BACKGROUND

Synchronous buck switchers are used in various electronic devices such as mobile phones, desktop computers and laptops. A synchronous buck switcher is essentially a circuit for converting high DC voltage to low DC voltage. A conventional synchronous buck switcher 100 is shown in FIG. 1. In synchronous buck switcher 100, a high input voltage (V_{IN}) is converted to a low output voltage (V_{OUT}) by using an error amplifier (EA) 102, a pulse width modulator (PWM) 104, a p-type metal-oxide-semiconductor field effect transistor (PMOS) device 106, and an n-type metal-oxide-semiconductor field effect transistor (NMOS) device 108. In addition to the elements mentioned above, synchronous buck switcher 100 includes an inductor 110, a capacitor 112, a first resistor 113, and a second resistor 114.

The circuitry of synchronous buck switcher 100, as depicted in FIG. 1 is fairly common, and a person ordinarily skilled in the art will understand that it gives a nominal output voltage as long as there is no current limit event in the circuit. A current limit event is said to occur when the current flowing through PMOS device 106 or inductor 110 suddenly increases. This usually occurs due to a sudden increase in the demand for load current across any load (not shown) connected to the V_{OUT} terminal.

This sudden increase of current is unacceptable, as it may damage inductor 110 and other components of synchronous buck switcher 100. Ideally, whenever a current limit event occurs, PMOS device 106 should be switched OFF instantaneously to reduce excessive current through inductor 110. One limitation of synchronous buck switcher 100 is that it does not have the provision for switching OFF PMOS device 106 when a current limit event occurs. Also, another limitation of the switcher is that there is no provision to re-regulate V_{OUT} when the current limit event elapses.

To overcome these limitations, several other synchronous buck switchers have been proposed in the prior art. In one of the prior art synchronous buck switchers, provisions are provided to switch OFF PMOS device 106 as soon as there is a current limit event. Further, voltage re-regulation begins in this switcher at the same output voltage which is present at the time when the current limit event elapses. A person skilled in the art will appreciate that in this switcher, since the current limit event causes the output voltage to fall below its nominal value, attempting re-regulation instantaneously after the current limit event causes the output voltage to overshoot and can thus result in damage to various components of the synchronous buck switcher and the load it is driving.

To overcome this limitation of the above mentioned prior art synchronous buck switcher, another synchronous buck switcher is currently in practice in which the output voltage is reduced to zero level whenever a current limit event occurs and then increased to its nominal or desired value (this process is commonly known as “soft start”). Although this switcher reduces the possibility of V_{OUT} overshoot, a considerable amount of time is required for V_{OUT} to return to its nominal value, considering the voltage is increased from the zero level. Also, in this switcher, even a short current limit event which would not have caused much sag in V_{OUT} results in an undesirable scenario of V_{OUT} being brought to the zero level and then increased back to its nominal value.

In light of the limitations of the prior art synchronous buck switchers, there is a need for a synchronous buck switcher that, upon recovery from a current limit event, does not cause the output voltage to overshoot or result in the output voltage being brought to the zero level before increasing it to its desired value.

### SUMMARY OF THE INVENTION

According to an embodiment of the present invention, a synchronous buck switcher is provided. The synchronous buck switcher includes a first loop including an error amplifier for comparing a feedback voltage with a reference voltage. The feedback voltage depends on the output voltage of the synchronous buck switcher. For example, when the output voltage of the switcher decreases, the feedback voltage also decreases and vice versa. In accordance with an embodiment of the present invention, the feedback voltage is fed into the non-inverting terminal of the error amplifier and the reference voltage is fed into the inverting terminal of the error amplifier.

The first loop further includes a pulse width modulator (PWM) connected between the output terminal of the error amplifier and a first input terminal of a logic gate, which can be, for example, an OR gate. Since the output of the error amplifier becomes the input of the PWM, the output of the PWM is based on the output of the error amplifier. In accordance with an embodiment of the present invention, the output of the PWM is low when the output of the error amplifier is less than a predefined threshold, and is high when the output of the error amplifier is greater than the predefined threshold. Typically, the predefined threshold is set by the level of a ramp voltage that is input to the PWM, and the output of the error amplifier is compared with the ramp voltage to produce an output of the PWM.

The first loop also includes a first power switch connected between the input voltage terminal of the synchronous buck switcher and an output inductor. The first power switch can be, for example, a p-type metal-oxide-semiconductor field effect transistor (PMOS) device, and its switching state is based on the output of the PWM. The first loop also includes a second power switch connected between the output inductor and ground. The second power switch can be, for example, an n-type metal-oxide-semiconductor field effect transistor (NMOS) device, and its switching state is complementary to the switching state of the first power switch, i.e., the PMOS device, and is based on the output of the PWM.

In accordance with an embodiment of the present invention, the PWM, the PMOS device, and the NMOS device are connected such that the PMOS device is switched OFF and the NMOS device is switched ON when the output of the PWM is high, and the PMOS device is switched ON and the NMOS device is switched OFF when the output of the PWM is low. Those ordinarily skilled in the art will appreciate that the switching states of the PMOS device and NMOS device, as mentioned above, are exemplary in nature and can be interchanged without deviating from the scope of the invention.

The synchronous buck switcher further includes a second loop including a first capacitor and a resistor connected in series between the output terminal of the error amplifier and the inverting terminal of the error amplifier. Furthermore, the synchronous buck switcher includes a current limit switch connected between the first capacitor and ground. The current limit switch can be, for example, an NMOS device. In accordance with an embodiment of the present invention, the current limit switch is switched ON when a current limit pulse is applied to the current limit switch, and the first capacitor starts to discharge when the current limit switch is switched ON. Typically, the current limit pulse is applied when a current limit event occurs in the synchronous buck switcher.

The synchronous buck switcher also includes a second capacitor connected between the inverting terminal of the error amplifier and ground. The second capacitor is connected such that it is in parallel connection with the current limit switch. Further, synchronous buck switcher includes a memory element, for example, an R-S flip flop, the input of which is the current limit pulse.

An objective of the present invention is to provide a synchronous buck switcher that does not cause the output voltage to overshoot when the synchronous buck switcher is brought back to its normal state after a current limit event has occurred. Also, the synchronous buck switcher according to the present invention does not cause the output voltage to decrease to zero before being brought back to its nominal level.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates a prior art synchronous buck switcher;

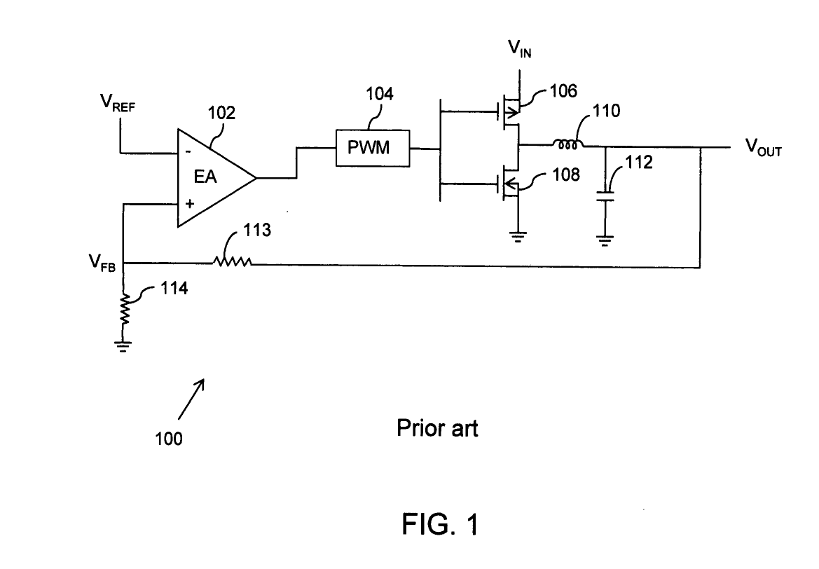

FIG. 2 illustrates a synchronous buck switcher, in accordance with an embodiment of the present invention; and

FIG. 3 are graphs illustrating a snapshot of a sample behavior of the synchronous buck switcher, in accordance with an embodiment of the present invention.

### DETAILED DESCRIPTION OF THE INVENTION

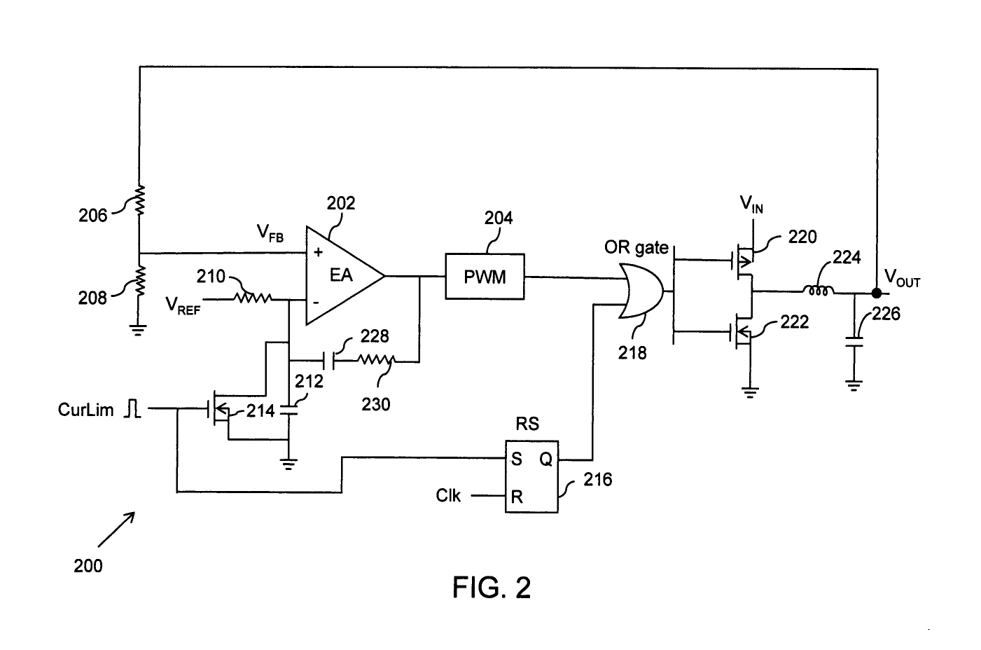

FIG. 2 illustrates a synchronous buck switcher 200, in accordance with an embodiment of the present invention. Synchronous buck switcher 200 includes an error amplifier (EA) 202 connected to a pulse width modulator (PWM) 204. The inputs of EA 202 are the feedback voltage (V_{FB}) and the reference voltage (V_{REF}). As shown in FIG. 2, V_{FB} is connected to the non-inverting terminal of EA 202 and depends on the output voltage (V_{OUT}) of synchronous buck switcher 200. Typically, V_{FB} is less than V_{OUT} as V_{OUT} is connected to the non-inverting terminal of EA 202 through a potential divider, shown as resistors 206 and 208. Further, V_{REF} is connected to the inverting terminal of EA 202 through a resistor 210, which is connected to a capacitor 212.

Capacitor 212 is connected between ground and resistor 210, and is connected in parallel to a current limit switch 214. In accordance with an embodiment of the present invention, current limit switch 214 is an NMOS device. The input to current limit switch 214 is a current limit pulse, which is applied to current limit switch 214 when a current limit event occurs. The working of current limit switch 214 and capacitor 212 will be described in detail later, when the working of synchronous buck switcher 200 during a current limit event is explained.

Synchronous buck switcher 200 further includes an RS flip flop 216, which has the current limit pulse as one of its inputs and a clock pulse as the other input. As shown in FIG. 2, the current limit pulse is given to the “SET” (S) input terminal of RS flip flop 216, and the clock pulse is given to the “RESET” (R) input terminal. The output of RS flip flop 216 is connected to one of the inputs of an OR gate 218, the other input of which is the output of PWM 204. Further, the output of OR gate 218 is connected to a PMOS device 220 and an NMOS device 222. PMOS device 220 and NMOS device 222 are connected in such a way that their switching states are complementary to each other. For example, when PMOS device 220 is in the ON state, NMOS device 222 is in the OFF state and vice versa.

In addition to the components mentioned above, synchronous buck switcher 200 includes an output inductor 224, an output capacitor 226, a capacitor 228, and a resistor 230. As shown in FIG. 2, V_{OUT} is the voltage across output capacitor 226. Further, capacitor 228 and resistor 230 are connected in series between the output terminal of EA 202 and the inverting terminal of EA 202.

The working of the components of synchronous buck switcher 200 during a current limit event will now be described.

A current limit event is said to occur when the current through PMOS device 220 and output inductor 224 increases (primarily due to a sudden increase in demand for load current from a load (not shown) connected to the V_{OUT} terminal). At this moment, a current limit pulse is applied to the SET terminal of RS flip flop 216, which causes the output of RS flip flop 216 to become high. This causes the output of PWM 204 to become redundant temporarily (in other words, PWM 204 goes “out of the circuit” temporarily) and the output of OR gate 218 to become high, irrespective of the state of PWM 204. Due to this, PMOS device 220 is driven to its OFF state. Also, due to the current limit event, capacitor 226 starts to discharge through the load (not shown), and this discharging capacitor 226 causes V_{OUT} to decrease, which in turn results in decreasing V_{FB} (which is the input of EA 202).

Since V_{FB} is decreasing, the loop containing capacitor 228 and resistor 230 “attempts” to pull down the voltage input of the inverting terminal of EA 202, to ensure that this voltage “follows” V_{FB}. Those ordinarily skilled in the art will know that it is a property of an error amplifier that it attempts to maintain both its input terminals at almost the same potential through a feedback loop (which in this case is formed by capacitor 228 and resistor 230). To achieve this, capacitor 212 needs to discharge to decrease the voltage input to the inverting terminal of EA 202. For this to happen, capacitor 228 needs to absorb the charge on capacitor 212 and also absorb the current that will come from V_{REF} and resistor 210 when the charge on capacitor 212 decreases. This is not possible in the present case as capacitor 228 is charged and cannot absorb extra charge from capacitor 212 or the current from V_{REF} and resistor 210.

To overcome this problem, the current limit pulse is also applied to current limit switch 214, which turns it ON, allowing capacitor 212 to discharge enough so that the feedback loop around EA 202 is able to regulate the inverting input terminal of EA 202 to the decreased value of the non-inverting input terminal of EA 202. At this point, when the current limiting pulse is over, the outer loop, including EA 202, PWM 204, PMOS device 220 and NMOS device 222, is again active and regulating at the decreased output voltage, V_{OUT}. The input to the inverting input terminal of EA 202 now increases as it is charged by V_{REF} through resistor 210. The output voltage, V_{OUT}, will now follow this increasing input to the inverting terminal of EA 202, as the output voltage “soft starts” from the value it was pulled down to by the current limit event. As V_{OUT} increases it will either soft start to the desired final V_{OUT} or another current limit event will occur and the same process will be repeated.

Those ordinarily skilled in the art will appreciate that the working of synchronous buck switcher 200 during a current limit event is different from prior art synchronous buck switchers, in that it does not cause the output voltage to overshoot or reduce to the zero level when the current limit event is over.

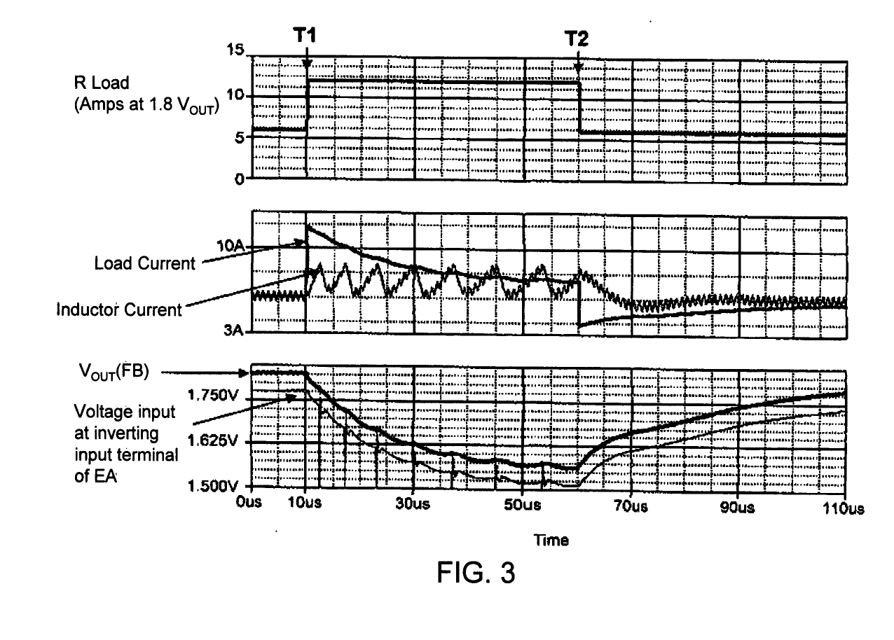

FIG. 3 illustrates a snapshot of a sample behavior of synchronous buck switcher 200, in accordance with an embodiment of the present invention. In the sample behavior, current is measured in Amperes (A), time is measured in microseconds (μs) and the output voltage, V_{OUT}, is assumed to be 1.8 Volts (V). Also, the current limit pulse which is applied at the start of current limit event is assumed to be of 30 nanoseconds (ns) time width.

As shown in FIG. 3, at time T1, a current limit event occurs and the demand for load current increases from 6 A to 12 A (shown in the first graph of FIG. 3 which is a graph of “demand for load current” as a function of time). This demand is maintained till time T2. The second graph, which is a graph of actual current and the inductor current (flowing through output inductor 224) as a function of time, shows that the inductor current increases to its maximum preset current limit of 8.5 A. The graph also shows the actual load current (the load current that actually goes out to the load, as opposed to the demand for the load current) which begins at 12 A and starts to decrease with time. Note that although the maximum preset current limit for synchronous buck switcher is 8.5 A, initially a load current of 12 A is provided to the load. This is because the additional current is provided by capacitor 226, which starts to discharge through the load. However, since the charge on capacitor 226 decreases continuously, the load current level of 12 A is not maintained and it decreases continuously.

As mentioned, at time T1 the current limit pulse of 30 ns is applied to current limit switch 214, which causes the voltage input at the inverting terminal of EA 202 (shown in the third graph) to “follow” decreasing V_{OUT} (or V_{FB}). Note that in actual practice, the voltage input to EA 202 is very close to V_{FB}, but it is shown offset in FIG. 3 for the sake of clarity.

As shown in the third graph of FIG. 3, which is a graph of voltage as a function of time, the input voltage at the inverting terminal of EA 202 continues to follows V_{FB} throughout the current limit event time period (T1 to T2) and even after that. This way, the output voltage starts to increase at the existing value of V_{OUT} at time T2 and there is no overshoot of voltage. Note that since at time T2, the demand for load has come back to its nominal value, capacitor 226 stops discharging through the load and the value of V_{OUT} starts to increase as capacitor 226 starts to get charged again by PMOS 220.

As shown in the second graph, at time T2, the extra load current is removed. Since the switcher is “regulating” at the lower voltage (1.56V rather than 1.8V), returning to the standard load requires less than the 6 A that was required at 1.8V (output voltage). At this time, the output voltage “soft starts” from 1.56V to 1.8V, and as explained in conjunction with FIG. 2, this is achieved by charging the inverting input terminal of the EA 202 through resistor 210 with the reference voltage, V_{REF}.

Various embodiments of the present invention provide several advantages. The synchronous buck switcher, according to the present invention, achieves recovery from a current limit event without causing the output voltage of the switcher to overshoot or to become zero before being brought back to its nominal value. This reduces the chances of damage to components of synchronous buck switcher and the load as the voltage does not overshoot, and also the recovery time is considerably reduced as the voltage is not reduced all the way to zero levels.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A synchronous buck switcher comprising:
a first loop comprising:
an error amplifier for comparing a feedback voltage with a reference voltage, wherein the feedback voltage is fed into a first input terminal of the error amplifier and the reference voltage is fed into a second input terminal of the error amplifier;
a pulse width modulator (PWM) connected between an output terminal of the error amplifier and a first input terminal of a logic gate, wherein an output of the PWM is based on an output of the error amplifier;
a first power switch connected between an input voltage terminal of the synchronous buck switcher and an output inductor, wherein the switching state of the first power switch is based on an output of the PWM;
a second power switch connected between the output inductor and ground, wherein the switching state of the second power switch is opposite to the switching state of the first power switch;
a second loop comprising a first capacitor and a resistor connected in series between the output terminal of the error amplifier and the second input terminal of the error amplifier;
a current limit switch connected between the first capacitor and ground, wherein the current limit switch is switched on when a current limit pulse is applied to the current limit switch, and wherein the first capacitor discharges when the current limit switch is switched on;
a second capacitor connected between the second input terminal of the error amplifier and ground, wherein the second capacitor is connected in parallel to the current limit switch; and
a memory element connected to a second input terminal of the logic gate, wherein an input to the memory element is the current limit pulse, and wherein the current limit pulse is applied to the memory element and the current limit switch when the current through the first power switch exceeds a preset value.

2. The synchronous buck switcher according to claim 1, wherein the feedback voltage is proportional to an output voltage of the synchronous buck switcher.

3. The synchronous buck switcher according to claim 1, wherein the output of the PWM is low when the output of the error amplifier is less than a predefined threshold, and the output of the PWM is high when the output of the error amplifier is greater than the predefined threshold.

4. The synchronous buck switcher according to claim 1, wherein the first power switch is switched off when the output of the PWM is high, and the first power switch is switched on when the output of the PWM is low.

5. The synchronous buck switcher according to claim 1, wherein the second power switch is switched off when the output of the PWM is low, and the second power switch is switched on when the output of the PWM is high.

6. The synchronous buck switcher according to claim 1, wherein the first power switch is a PMOS device and the second power switch is an NMOS device.

7. The synchronous buck switcher according to claim 1, wherein the logic gate is an OR gate.

8. The synchronous buck switcher according to claim 1, wherein the first loop regulates an output voltage of the synchronous buck switcher based on a preset nominal output voltage value.

9. The synchronous buck switcher according to claim 1, wherein the memory element is an RS flip flop.

10. The synchronous buck switcher according to claim 1, wherein the output inductor is connected to an output voltage terminal of the synchronous buck switcher.
